(19) United States
(12) Patent Application Publication
(10) Pub. No.: US 2008/0316234 A1
(43) Pub. Date: Dec. 25, 2008

(54) Method of driving electro-optical device, source driver, electro-optical device, projection-type display device, and electronic instrument

(75) Inventor: Yuichi Toriumi, Fujimi-machi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/213,440

(22) Filed: Jun. 19, 2008

(30) Foreign Application Priority Data
Jun. 20, 2007 (JP) 2007-162755

(51) Int. Cl. G09G 5/10

(52) U.S. Cl. 345/690

(57) ABSTRACT

A method of driving an electro-optical device that drives a source line of the electro-optical device based on K-bit (K is an integer equal to or larger than two) grayscale data includes, when data of a most significant bit of the grayscale data is first data, generating converted grayscale data by converting data of lower-order (K-L) bits (K>L, L is a positive integer) of the grayscale data so that a code word distance between the data of the lower-order (K-L) bits of the grayscale data before conversion and the data of the lower-order (K-L) bits of the grayscale data after conversion is equal to or less than (K-L); and driving the source line based on a grayscale signal corresponding to the converted data in a first polarity drive period, and driving the source line based on a grayscale signal corresponding to data obtained by converting higher-order L bits of the converted data so that a code word distance between data of the higher-order L bits of the converted data before conversion and the data of the higher-order L bits of the converted data after conversion is equal to or less than L in a second polarity drive period.

Japanese Patent Application No. 2007-162755 filed on Jun. 20, 2007, is hereby incorporated by reference in its entirety.

### BACKGROUND OF THE INVENTION

The present invention relates to a method of driving an electro-optical device, a source driver, an electro-optical device, a projection-type display device, an electronic instrument, and the like.

As a liquid crystal panel (electro-optical device) used for electronic instruments such as portable telephones, a simple matrix type liquid crystal panel and an active matrix type liquid crystal panel using a switch element such as a thin film transistor (hereinafter abbreviated as “TFT”) have been known.

The simple matrix method can easily reduce power consumption as compared with the active matrix method. On the other hand, it is difficult to increase the number of colors or display a video image using the simple matrix method. The active matrix method is suitable for increasing the number of colors or displaying a video image, but has difficulty in reducing power consumption.

In recent years, an increase in the number of colors and a video image display have been increasingly desired for portable electronic instruments such as portable telephones in order to provide a high-quality image. Therefore, an active matrix type liquid crystal panel has been increasingly used instead of a simple matrix type liquid crystal panel.

JP-A-2005-252974 discloses a source driver that drives such a liquid crystal panel, for example. JP-A-2005-252974 discloses technology in which one of a plurality of analog voltages is selected based on digital grayscale data, and a source line of a liquid crystal panel is driven based on the selected analog voltage.

A liquid crystal (electro-optical element) used for such a liquid crystal panel deteriorates when a voltage of a single polarity is applied to the liquid crystal for a long time. Therefore, polarity inversion drive that drives a liquid crystal while reversing the polarity of the voltage applied to the liquid crystal is generally performed when driving a liquid crystal panel. Polarity inversion drive is implemented by changing an analog voltage corresponding to polarity or converting grayscale data corresponding to polarity.

However, when changing an analog voltage corresponding to polarity, each node is frequently charged or discharged so that it takes time until the potential of each node becomes stable. Therefore, when the drive period is reduced and the number of grayscales increases, the accuracy of the potential corresponding to each grayscale value decreases, whereby the image quality deteriorates.

On the other hand, since all bits of the grayscale data are reversed corresponding to polarity when converting the grayscale data corresponding to polarity, an inversion circuit that reverses all bits of the grayscale data is provided corresponding to each source output. This results in an increase in circuit scale and an increase in current consumption due to the all-bit inversion process. The number of source outputs will increase and the source output pitch will decrease significantly in the future. Therefore, it is necessary to suppress an increase in circuit scale while reducing power consumption.

### SUMMARY

According to one aspect of the invention, there is a method of driving an electro-optical device that drives a source line of the electro-optical device that has an electro-optical element based on K-bit (K is an integer equal to or larger than two) grayscale data, the method comprising:

when data of a most significant bit of the grayscale data is first data, generating converted grayscale data by converting data of lower-order (K-L) bits (K>L, L is a positive integer) of the grayscale data so that a code word distance between the data of the lower-order (K-L) bits of the grayscale data before conversion and the data of the lower-order (K-L) bits of the grayscale data after conversion is equal to or less than (K-L); and

driving the source line based on a grayscale signal corresponding to the converted data in a first polarity drive period when a signal applied to the electro-optical element has a first polarity, and driving the source line based on a grayscale signal corresponding to data obtained by converting higher-order L bits of the converted data so that a code word distance between data of the higher-order L bits of the converted data before conversion and the data of the higher-order L bits of the converted data after conversion is equal to or less than L in a second polarity drive period when the signal applied to the electro-optical element has a second polarity.

According to another aspect of the invention, there is provided a method of driving an electro-optical device that drives a source line of the electro-optical device that has an electro-optical element based on K-bit (K is an integer equal to or larger than two) grayscale data, the method comprising:

generating converted grayscale data by converting data of lower-order (K-L) bits (K>L, L is a positive integer) of the grayscale data, and storing the converted data in a buffer; and

driving the source line based on a grayscale signal corresponding to the converted data read from the buffer in a first polarity drive period when a signal applied to the electro-optical element has a first polarity, and driving the source line based on a grayscale signal corresponding to data obtained by converting higher-order L bits of the converted data read from the buffer in a second polarity drive period when the signal applied to the electro-optical element has a second polarity, so that a number of times that the data of the higher-order L bits of the converted grayscale data is converted is reduced as compared with a number of times that the data of the lower-order (K-L) bits of the converted grayscale data is converted in the first polarity drive period and the second polarity drive period.

According to another aspect of the invention, there is provided a source driver that drives a source line of an electro-optical device that has an electro-optical element based on K-bit (K is an integer equal to or larger than two) grayscale data, the source driver comprising:

a converted data generation circuit, when data of a most significant bit of the grayscale data is first data, the converted data generation circuit generating converted grayscale data by converting data of lower-order (K-L) bits (K>L, L is a positive integer) of the grayscale data so that a code word distance between the data of the lower-order (K-L) bits of the grayscale data before conversion and the data of the lower-order (K-L) bits of the grayscale data after conversion is equal to or less than (K-L); and

a source line driver circuit that drives the source line based on a grayscale signal corresponding to the converted data in a first polarity drive period when a signal applied to the electro-optical element has a first polarity, and drives the source line based on a grayscale signal corresponding to data obtained by converting higher-order L bits of the converted data so that a code word distance between data of the higher-order L bits of the converted data before conversion and the data of the higher-order L bits of the converted data after conversion is equal to or less than L in a second polarity drive period when the signal applied to the electro-optical element has a second polarity.

According to another aspect of the invention, there is provided an electro-optical device comprising the above source driver.

According to another aspect of the invention, there is provided a projection-type display device comprising the above source driver.

According to another aspect of the invention, there is provided an electronic instrument comprising the above source driver.

### BRIEF DESCRIPTION OF THE SEVERAL VIEWS OF THE DRAWING

FIG. 1 is a view showing an outline of the configuration of a liquid crystal device according to one embodiment of the invention.

FIG. 2 is a view showing an outline of another configuration of a liquid crystal device according to one embodiment of the invention.

FIG. 3 is a block diagram showing a configuration example of a gate driver shown in FIG. 1 or 2.

FIG. 4 is a block diagram showing a configuration example of a source driver shown in FIG. 1 or 2.

FIG. 5 is a view illustrative of the operation of a converted data generation circuit according to one embodiment of the invention.

FIG. 6 is a view illustrative of the operation of a converted data generation circuit according to one embodiment of the invention when K is “4” and L is “1”.

FIG. 7 shows an example of a signal path selected based on grayscale data generated using an all-bit inversion method.

FIG. 8 shows an example of a signal path selected based on converted grayscale data according to one embodiment of the invention.

FIG. 9 is a view illustrative of the operation of a converted data generation circuit according to one embodiment of the invention when K is “4” and L is “2”.

FIG. 10 is a view showing an outline of the configuration of a converted data generation circuit shown in FIG. 4.

FIG. 11 a circuit diagram showing a configuration example of an R-component converted data generation circuit shown in FIG. 10.

FIG. 12 is a view showing a configuration example of a decoder included in a DAC shown in FIG. 4.

FIG. 13 is a circuit diagram showing a configuration example of a predecoder.

FIG. 14 is a view showing a configuration example of a p-type selector shown in FIG. 12.

FIG. 15 is a view illustrative of grayscale voltages supplied to p-type third selectors shown in FIG. 14.

FIG. 16 is a view showing a configuration example of an n-type selector shown in FIG. 12.

FIG. 17 is a view illustrative of grayscale voltages supplied to n-type third selectors shown in FIG. 16.

FIG. 18 shows a comparison between a grayscale voltage supply example according to one embodiment of the invention and a grayscale voltage supply example when using an all-bit inversion method.

FIG. 19 is a block diagram showing a configuration example of a projection-type display device to which a liquid crystal device according to one embodiment of the invention is applied.

FIG. 20 is a schematic view showing the main portion of a projection-type display device.

FIG. 21 is a block diagram showing a configuration example of a portable telephone to which a liquid crystal device according to one embodiment of the invention is applied.

### DETAILED DESCRIPTION OF THE EMBODIMENT

Several aspects of the invention may provide a method of driving an electro-optical device, a source driver, an electro-optical device, a projection-type display device, and an electronic instrument that implement polarity inversion drive with a reduced circuit scale and reduced power consumption.

According to one embodiment of the invention, there is provided a method of driving an electro-optical device that drives a source line of the electro-optical device that has an electro-optical element based on K-bit (K is an integer equal to or larger than two) grayscale data, the method comprising:

when data of a most significant bit of the grayscale data is first data, generating converted grayscale data by converting data of lower-order (K-L) bits (K>L, L is a positive integer) of the grayscale data so that a code word distance between the data of the lower-order (K-L) bits of the grayscale data before conversion and the data of the lower-order (K-L) bits of the grayscale data after conversion is equal to or less than (K-L); and

driving the source line based on a grayscale signal corresponding to the converted data in a first polarity drive period when a signal applied to the electro-optical element has a first polarity, and driving the source line based on a grayscale signal corresponding to data obtained by converting higher-order L bits of the converted data so that a code word distance between data of the higher-order L bits of the converted data before conversion and the data of the higher-order L bits of the converted data after conversion is equal to or less than L in a second polarity drive period when the signal applied to the electro-optical element has a second polarity.

According to this embodiment, the grayscale data is converted into the converted data in advance, and the source line is driven based on the grayscale signal corresponding to data obtained by converting only the higher-order L bits of the converted data in the second polarity drive period. Therefore, the number of nodes to be charged or discharged accompanying a change in grayscale data can be reduced in the first polarity drive period and the second polarity drive period as compared with the case of reversing all bits of the grayscale data, whereby current consumption can be reduced. Moreover, since only the higher-order L bits of the converted data are converted corresponding to polarity, the circuit scale can be reduced as compared with the case of reversing all bits of the grayscale data.

In the method of driving an electro-optical device according to this embodiment,

the method may include:

storing the converted data in a buffer;

driving the source line based on a grayscale signal corresponding to the converted data read from the buffer in the first polarity drive period; and

driving the source line based on a grayscale signal corresponding to data obtained by converting the higher-order L bits of the converted data read from the buffer so that a code word distance between data of the higher-order L bits of the converted data before conversion and the data of the higher-order L bits of the converted data after conversion is equal to or less than L in the second polarity drive period.

According to this embodiment, the grayscale data is converted into the converted data before storing the grayscale data in the buffer, and the converted data is stored in the buffer. Therefore, it suffices to convert only the higher-order L bits of the converted data during polarity inversion drive. Specifically, the circuit scale of a conversion circuit used for polarity inversion drive can be reduced as compared with the case of reversing all bits of the grayscale data. Moreover, since the data of the lower-order (K-L) bits of the converted data is not changed, the amount of charging or discharging can be reduced correspondingly.

According to another embodiment of the invention, there is provided a method of driving an electro-optical device that drives a source line of the electro-optical device that has an electro-optical element based on K-bit (K is an integer equal to or larger than two) grayscale data, the method comprising:

generating converted grayscale data by converting data of lower-order (K-L) bits (K>L, L is a positive integer) of the grayscale data, and storing the converted data in a buffer; and

driving the source line based on a grayscale signal corresponding to the converted data read from the buffer in a first polarity drive period when a signal applied to the electro-optical element has a first polarity, and driving the source line based on a grayscale signal corresponding to data obtained by converting higher-order L bits of the converted data read from the buffer in a second polarity drive period when the signal applied to the electro-optical element has a second polarity, so that a number of times that the data of the higher-order L bits of the converted grayscale data is converted is reduced as compared with a number of times that the data of the lower-order (K-L) bits of the converted grayscale data is converted in the first polarity drive period and the second polarity drive period.

According to this embodiment, if the lower-order (K-L) bits of the grayscale data have been converted, only the higher-order L bits of the converted data are converted each time polarity inversion drive is performed. Therefore, the number of nodes to be charged or discharged accompanying a change in grayscale data can be reduced, whereby current consumption can be reduced. Moreover, the circuit scale can be reduced as compared with the case of reversing all bits of the grayscale data.

In the method of driving an electro-optical device according to this embodiment,

L may be one.

According to this embodiment, since the code word distance can be minimized, the number of nodes to be charged or discharged in the first polarity drive period and the second polarity drive period can be reduced, whereby power consumption can be reduced to a large extent.

According to another embodiment of the invention, there is provided a source driver that drives a source line of an electro-optical device that has an electro-optical element based on K-bit (K is an integer equal to or larger than two) grayscale data, the source driver comprising:

a converted data generation circuit, when data of a most significant bit of the grayscale data is first data, the converted data generation circuit generating converted grayscale data by converting data of lower-order (K-L) bits (K>L, L is a positive integer) of the grayscale data so that a code word distance between the data of the lower-order (K-L) bits of the grayscale data before conversion and the data of the lower-order (K-L) bits of the grayscale data after conversion is equal to or less than (K-L); and

a source line driver circuit that drives the source line based on a grayscale signal corresponding to the converted data in a first polarity drive period when a signal applied to the electro-optical element has a first polarity, and drives the source line based on a grayscale signal corresponding to data obtained by converting higher-order L bits of the converted data so that a code word distance between data of the higher-order L bits of the converted data before conversion and the data of the higher-order L bits of the converted data after conversion is equal to or less than L in a second polarity drive period when the signal applied to the electro-optical element has a second polarity.

According to this embodiment, the grayscale data is converted into the converted data in advance, and the source line is driven based on the grayscale signal corresponding to data obtained by converting only the higher-order L bits of the converted data in the second polarity drive period. Therefore, the number of nodes to be charged or discharged accompanying a change in grayscale data can be reduced in the first polarity drive period and the second polarity drive period as compared with the case of reversing all bits of the grayscale data, whereby current consumption can be reduced. Moreover, since only the higher-order L bits of the converted data are converted corresponding to polarity, the circuit scale can be reduced as compared with the case of reversing all bits of the grayscale data.

In the source driver according to this embodiment,

the source driver may further include a buffer that stores the converted data,

the source line driver circuit may drive the source line based on a grayscale signal corresponding to the converted data read from the buffer in the first polarity drive period, and may drive the source line based on a grayscale signal corresponding to data obtained by converting the higher-order L bits of the converted data read from the buffer so that so that a code word distance between data of the higher-order L bits of the converted data before conversion and the data of the higher-order L bits of the converted data after conversion is equal to or less than L in the second polarity drive period.

According to this embodiment, the grayscale data is converted into the converted data before storing the grayscale data in the buffer, and the converted data is stored in the buffer. Therefore, it suffices to convert only the higher-order L bits of the converted data during polarity inversion drive. Specifically, the circuit scale of a conversion circuit used for polarity inversion drive can be reduced as compared with the case of reversing all bits of the grayscale data. Moreover, since the data of the lower-order (K-L) bits of the converted data is not changed, the amount of charging or discharging can be reduced correspondingly.

In the source driver according to this embodiment, L may be one.

According to this embodiment, since the code word distance can be minimized, the number of nodes to be charged or discharged in the first polarity drive period and the second polarity drive period can be reduced, whereby power consumption can be reduced to a large extent.

In the source driver according to this embodiment,

the source line driver circuit may include a most significant bit inversion circuit that reverses only the most significant bit of the converted grayscale data in the second polarity drive period.

According to this embodiment, since the most significant bit inversion circuit is provided corresponding to each source output, the circuit scale can be significantly reduced as compared with the case of reversing all bits of the grayscale data.

According to another embodiment of the invention, there is provided an electro-optical device comprising:

a plurality of gate lines;

a plurality of source lines;

a plurality of pixels, each of the plurality of pixels being specified by a corresponding gate line among the plurality of gate lines and a corresponding source line among the plurality of source lines;

a gate driver that scans the plurality of gate lines; and

one of the above source drivers that drives the plurality of source lines.

According to another embodiment of the invention, there is provided an electro-optical device comprising one of the above source drivers.

According to this embodiment, an electro-optical device that implements polarity inversion drive with a reduced circuit scale and reduced power consumption can be provided.

According to another embodiment of the invention, there is provided a projection-type display device comprising:

the above electro-optical device;

a light source that emits light that enters the electro-optical device; and

projection means that projects light emitted from the electro-optical device.

According to another embodiment of the invention, there is provided a projection-type display device comprising one of the above source drivers.

According to this embodiment, a projection-type display device that implements polarity inversion drive with a reduced circuit scale and reduced power consumption can be provided.

According to another embodiment of the invention, there is provided an electronic instrument comprising the above electro-optical device.

According to another embodiment of the invention, there is provided an electronic instrument comprising:

the above electro-optical device; and

means that supplies grayscale data to the electro-optical device.

According to another embodiment of the invention, there is provided an electronic instrument comprising one of the above source drivers.

According to this embodiment, an electronic instrument that implements polarity inversion drive with a reduced circuit scale and reduced power consumption can be provided.

Embodiments of the invention are described in detail below with reference to the drawings. Note that the embodiments described below do not in any way limit the scope of the invention laid out in the claims. Note that all elements of the embodiments described below should not necessarily be taken as essential requirements for the invention.

1. Liquid Crystal Device

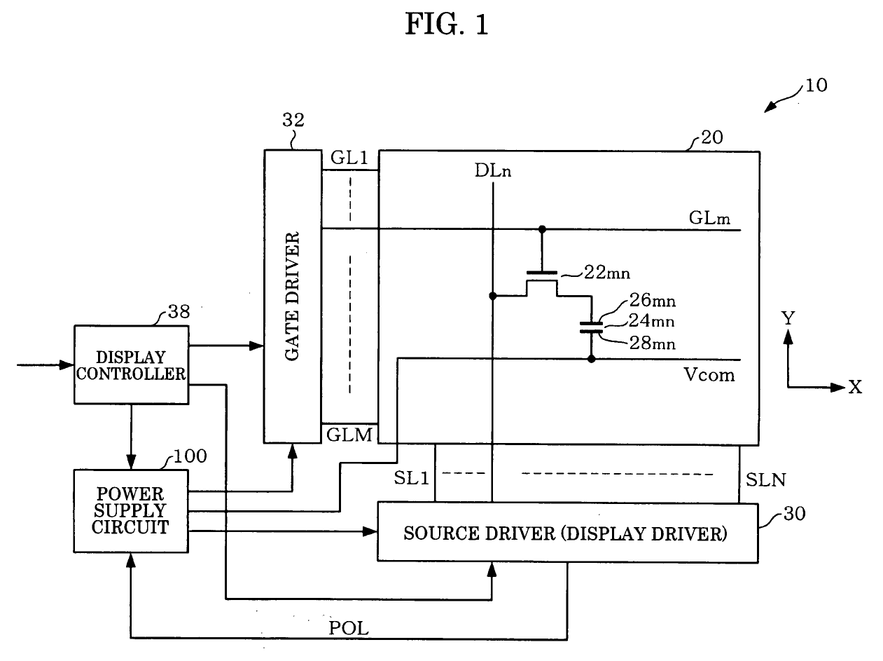

FIG. 1 schematically shows the configuration of an active matrix type liquid crystal device according to one embodiment of the invention.

A liquid crystal device 10 includes a liquid crystal display (LCD) panel (display panel in a broad sense; electro-optical device in a broader sense) 20. The LCD panel 20 is formed on a glass substrate, for example. A plurality of gate lines (scan lines) GL1 to GLM (M is an integer equal to or larger than two), arranged in a direction Y and extending in a direction X, and a plurality of source lines (data lines) SL1 to SLN (N is an integer equal to or larger than two), arranged in the direction X and extending in the direction Y, are disposed on the glass substrate. A pixel area (pixel) is provided corresponding to the intersection of the gate line GLm (1≦m≦M, m is an integer; hereinafter the same) and the source line SLn (1≦n≦N, n is an integer; hereinafter the same). A thin film transistor (hereinafter abbreviated as “TFT”) 22 mm is disposed in the pixel area.

The gate of the TFT 22 mn is connected to the gate line GLm. The source of the TFT 22 mn is connected to the source line SLn. The drain of the TFT 22 mn is connected to a pixel electrode 26 mn. A liquid crystal is sealed between the pixel electrode 26 mn and a common electrode 28 mn opposite to the pixel electrode 26 mn so that a liquid crystal capacitor (liquid crystal element in a broad sense) 24 mn is formed. The transmissivity of the pixel changes corresponding to the voltage applied between the pixel electrode 26 mn and the common electrode 28 mn. A common electrode voltage Vcom is supplied to the common electrode 28 mn.

The LCD panel 20 is formed by bonding a first substrate provided with the pixel electrode and the TFT and a second substrate provided with the common electrode, and sealing a liquid crystal (electro-optical material) between the first and second substrates, for example.

The liquid crystal device 10 includes a source driver (display driver in a broad sense; driver circuit in a broader sense) 30. The source driver 30 drives the source lines SL1 to SLN of the LCD panel 20 based on grayscale data.

The liquid crystal device 10 may include a gate driver (scan driver in a broad sense) 32. The gate driver 32 scans the gate lines GL1 to GLM of the LCD panel 20 within one vertical scan period.

The liquid crystal device 10 may include a power supply circuit 100. The power supply circuit 100 generates voltages necessary for driving the source lines, and supplies the generated voltages to the source driver 30. For example, the power supply circuit 100 generates power supply voltages VDDH and VSSH necessary for the source driver 30 to drive the source lines, and voltages necessary for a logic section of the source driver 30.

The power supply circuit 100 also generates voltages necessary for scanning the gate lines, and supplies the generated voltages to the gate driver 32.

The power supply circuit 100 also generates the common electrode voltage Vcom. The power supply circuit 100 outputs the common electrode voltage Vcom to the common electrode of the LCD panel 20. The common electrode voltage Vcom is periodically set at a high-potential-side voltage VCOMH and a low-potential-side voltage VCOML in synchronization with the timing of a polarity inversion signal POL generated by the source driver 30.

The liquid crystal device 10 may include a display controller 38. The display controller 38 controls the source driver 30, the gate driver 32, and the power supply circuit 100 according to information set by a host (not shown) such as a central processing unit (hereinafter abbreviated as “CPU”). For example, the display controller 38 sets the operation mode of the source driver 30 and the gate driver 32, and supplies a vertical synchronization signal and a horizontal synchronization signal generated therein to the source driver 30 and the gate driver 32. The display controller 38 or the host may supply grayscale data to the source driver 30.

In FIG. 1, the liquid crystal device 10 includes the power supply circuit 100 and the display controller 38. Note that at least one of the power supply circuit 100 and the display controller 38 may be provided outside the liquid crystal device 10. Or, the liquid crystal device 10 may include the host.

The source driver 30 may include at least one of the gate driver 32 and the power supply circuit 100.

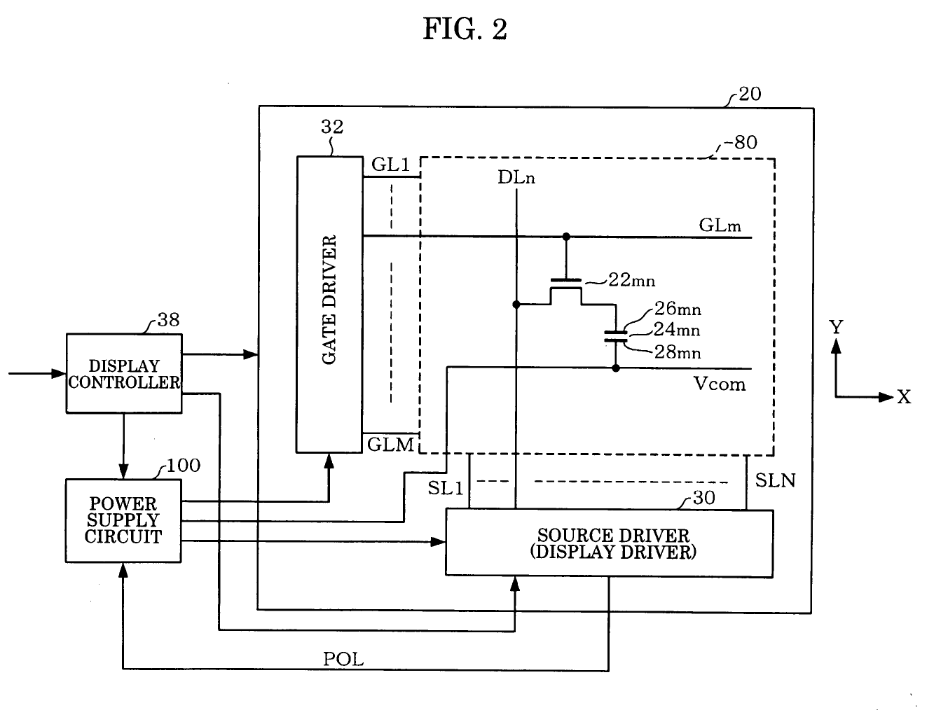

Some or all of the source driver 30, the gate driver 32, the display controller 38, and the power supply circuit 100 may be formed on the LCD panel 20. In FIG. 2, the source driver 30 and the gate driver 32 are formed on the LCD panel 20. Specifically, the LCD panel 20 may include a plurality of source lines, a plurality of gate lines, a plurality of switch elements, each of the plurality of switch elements being connected to a corresponding gate line among the plurality of gate lines and a corresponding source line among the plurality of source lines, and a display driver that drives the plurality of source lines. A plurality of pixels are formed in a pixel formation area 80 of the LCD panel 20.

1.1 Gate Driver

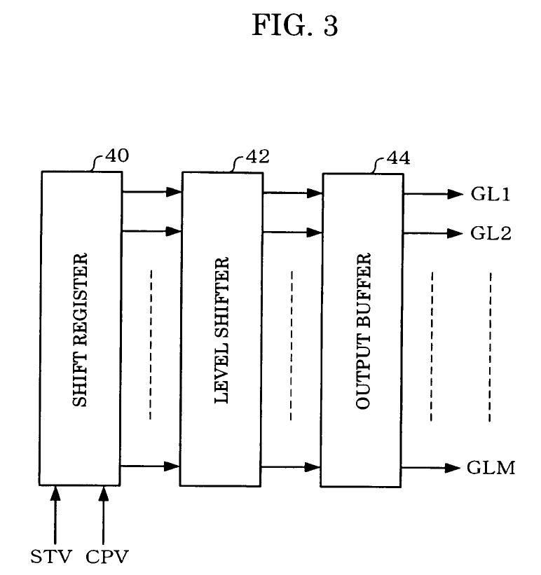

FIG. 3 shows a configuration example of the gate driver 32 shown in FIG. 1 or 2.

The gate driver 32 includes a shift register 40, a level shifter 42, and an output buffer 44.

The shift register 40 includes a plurality of flip-flops provided corresponding to the gate lines and sequentially connected. The shift register 40 holds a start pulse signal STV in the flip-flop in synchronization with a clock signal CPV, and sequentially shifts the start pulse signal STV to the adjacent flip-flops in synchronization with the clock signal CPV. The clock signal CPV is a horizontal synchronization signal, and the start pulse signal STV is a vertical synchronization signal.

The level shifter 42 shifts the level of the voltage input from the shift register 40 to a voltage level corresponding to the liquid crystal element of the LCD panel 20 and the transistor performance of the TFT. A high voltage level of 20 to 50 V is required as this voltage level, for example.

The output buffer 44 buffers a scan voltage shifted by the level shifter 42, and outputs the scan voltage to the gate line to drive the gate line.

2. Source Driver

2.1 Outline of Configuration

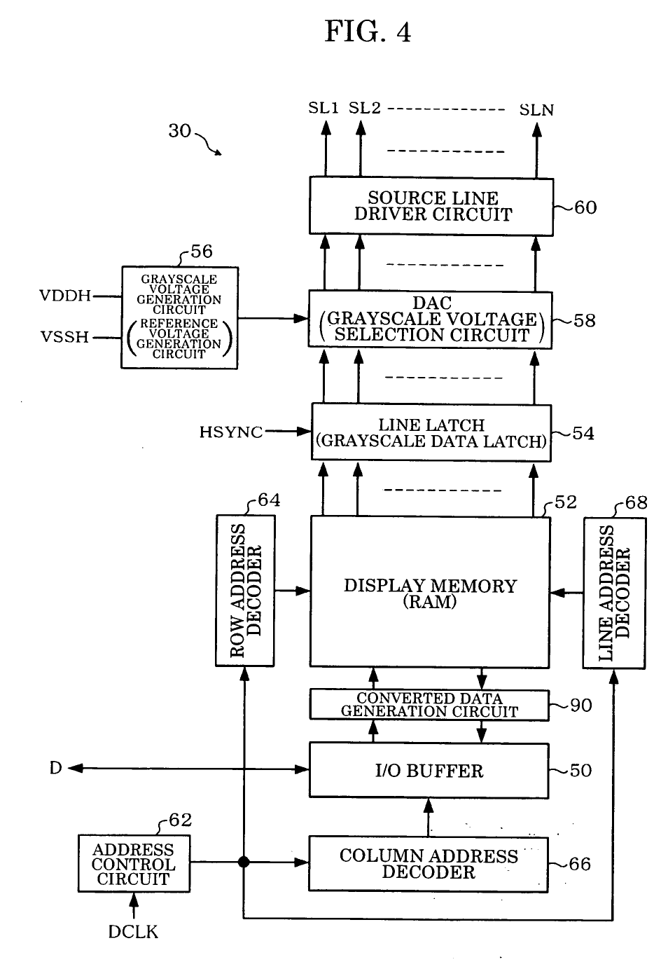

FIG. 4 is a block diagram showing a configuration example of the source driver 30 shown in FIG. 1 or 2.

The source driver 30 includes a converted data generation circuit 90, an I/O buffer 50, a display memory 52, a line latch 54, a grayscale voltage generation circuit (reference voltage generation circuit in a broad sense) 56, a digital/analog converter (DAC) 58 (grayscale voltage selection circuit in a broad sense), and a source line driver circuit (source line driver section) 60.

For example, grayscale data D is input to the source driver 30 from the display controller 38. The number of bits of each of RGB color components of the grayscale data D is K (K is an integer equal to or larger than two). The grayscale data D is input in synchronization with a dot clock signal DCLK, and is buffered by the I/O buffer 50. The dot clock signal DCLK is supplied from the display controller 38.

The display controller 38 or the host (not shown) accesses the I/O buffer 50. The grayscale data buffered by the I/O buffer 50 is converted into converted grayscale data (converted data in a broad sense) by the converted data generation circuit 90, and written into the display memory 52 (grayscale data memory, frame memory, or frame buffer; buffer in a broad sense).

The converted data generation circuit 90 generates the converted grayscale data by converting the grayscale data so that a drive signal corresponding to the grayscale data can be output without reversing all bits of the grayscale data in a positive period (i.e., a period in which the polarity inversion signal POL is set at the H level) and a negative period (i.e., a period in which the polarity inversion signal POL is set at the L level) during polarity inversion drive. Specifically, in the case where a drive signal corresponding to K-bit (K is an integer equal to or larger than two) grayscale data is output from each source output of the source driver 30, when the data of the most significant bit (MSB) of the grayscale data is “1” (first data in a broad sense), the converted data generation circuit 90 generates the converted grayscale data by converting the data of the lower-order (K-L) bits (K>L, L is a positive integer) of the grayscale data so that the code word distance between the data of the lower-order (K-L) bits of the grayscale data before conversion and the data of the lower-order (K-L) bits of the grayscale data after conversion is equal to or less than (K-L). L may be referred as the number of higher-order bits of the grayscale data.

When the grayscale data or the converted grayscale data (converted data) is expressed by a bit string, 2^{m} code words can be expressed. The code word distance (or hamming distance) refers to the number of bits of which the value differs between two pieces of data. For example, when m is six, the code word distance between data “000000” and data “000001” is “1”, and the code word distance between data “010101” and data “101010” is “6”.

When the data of the MSB of the grayscale data is “0” (second data in a broad sense), the converted data generation circuit 90 outputs the grayscale data as the converted grayscale data without converting the grayscale data. The converted grayscale data thus generated is stored in the display memory 52.

The converted grayscale data read from the display memory 52 is inversely converted into the input data by the converted data generation circuit 90, buffered by the I/O buffer 50, and output to the display controller 38 and the like. The converted grayscale data read from the display memory 52 may be restored to the grayscale data before conversion by the converted data generation circuit 90, buffered by the I/O buffer 50, and output to the display controller 38 and the like, for example.

The display memory 52 includes a plurality of memory cells provided corresponding to output lines connected to the source lines. Each memory cell is specified by a row address and a column address. The memory cells corresponding to one scan line are specified by a line address.

An address control circuit 62 generates the row address, the column address, and the line address that specify a memory cell of the display memory 52. The address control circuit 62 generates the row address and the column address when writing the converted grayscale data into the display memory 52. Specifically, the converted grayscale data buffered by the I/O buffer 50 is written into the memory cell of the display memory 52 specified by the row address and the column address.

A row address decoder 64 decodes the row address, and selects the memory cells of the display memory 52 corresponding to the row address. A column address decoder 66 decodes the column address, and selects the memory cells of the display memory 52 corresponding to the column address.

The address control circuit 62 generates the line address when reading the converted grayscale data from the display memory 52 and outputting the converted grayscale data to the line latch 54. Specifically, a line address decoder 68 decodes the line address, and selects the memory cells of the display memory 52 corresponding to the line address. The converted grayscale data corresponding to one horizontal scan read from the memory cells specified by the line address is output to the line latch 54.

The address control circuit 62 generates the row address and the column address when reading the converted grayscale data from the display memory 52 and outputting the converted grayscale data to the I/O buffer 50. Specifically, the converted grayscale data stored in the memory cell of the display memory 52 specified by the row address and the column address is read and written into the I/O buffer 50. The converted grayscale data written into the I/O buffer 50 is acquired by the display controller 38 or the host (not shown).

Therefore, the row address decoder 64, the column address decoder 66, and the address control circuit 62 shown in FIG. 4 function as a write control circuit that controls writing of the converted grayscale data into the display memory 52. The line address decoder 68, the column address decoder 66, and the address control circuit 62 shown in FIG. 4 function as a read control circuit that controls reading of the converted grayscale data from the display memory 52.

The line latch 54 latches the converted grayscale data corresponding to one horizontal scan read from the display memory 52 at a change timing of a horizontal synchronization signal HSYNC. The line latch 54 includes a plurality of registers, each of the registers storing the converted grayscale data corresponding to one dot. The converted grayscale data corresponding to one dot read from the display memory 52 is stored in each register of the line latch 54.

The grayscale voltage generation circuit 56 generates a plurality of grayscale voltages (reference voltages) (grayscale signals in a broad sense) respectively corresponding to the converted grayscale data. Specifically, the grayscale voltage generation circuit 56 generates a plurality of grayscale voltages respectively corresponding to the converted grayscale data based on a high-potential-side power supply voltage VDDH and a low-potential-side power supply voltage VSSH. The grayscale voltage generation circuit 56 includes a resistor circuit (ladder resistor circuit), the high-potential-side power supply voltage VDDH and the low-potential-side power supply voltage VSSH being supplied to the ends of the resistor circuit. The grayscale voltage generation circuit 56 outputs voltages at a plurality of division nodes of the resistor circuit as the grayscale voltages.

The DAC 58 generates the grayscale voltages corresponding to the converted grayscale data output from the line latch 54 corresponding to output lines (outputs) of the source line driver circuit 60. Specifically, the DAC 58 selects the grayscale voltage corresponding to the converted grayscale data corresponding to one output line of the source line driver circuit 60 output from the line latch 54, from the grayscale voltages generated by the grayscale voltage generation circuit 56, and outputs the selected grayscale voltage.

The source line driver circuit 60 drives a plurality of output lines respectively connected to the source lines of the LCD panel 20. Specifically, the source line driver circuit 60 drives the output lines based on the grayscale voltages output from voltage selection circuits of the DAC 58 corresponding to the output lines. More specifically, the source line driver circuit 60 drives the source line based on the grayscale voltage (grayscale signal) corresponding to the converted grayscale data in a positive drive period (i.e., the signal applied to the electro-optical element has a first polarity). The source line driver circuit 60 drives the source line based on the grayscale signal corresponding to data obtained by converting the higher-order L bits of the converted grayscale data so that the code word distance between the higher-order L bits of the grayscale data before conversion and the higher-order L bits of the grayscale data after conversion is equal to or less than L, in a negative drive period (i.e., the signal applied to the electro-optical element has a second polarity).

The source line driver circuit 60 includes output circuits provided corresponding to the output lines. Each output circuit drives the source line based on the grayscale voltage output from the corresponding voltage selection circuit. Each output circuit is a voltage follower circuit. The voltage follower circuit may be formed using a voltage-follower-connected operational amplifier or the like.

2.2 Drive Method According to this Embodiment

A grayscale data conversion process according to this embodiment and a method of driving the LCD panel 20 based on the converted grayscale data generated by the conversion process are described below.

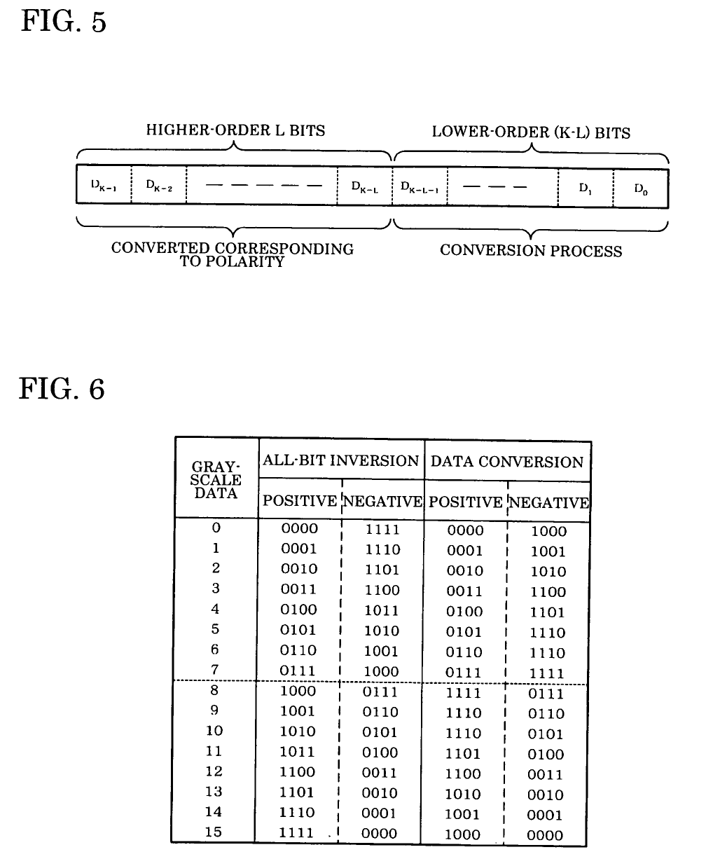

FIG. 5 is a view illustrative of the operation of the converted data generation circuit 90 according to this embodiment.

In FIG. 5, the data of the higher-order L bits of the K-bit grayscale data is converted each time polarity inversion occurs, and the data of the lower-order (K-L) bits of the K-bit grayscale data is converted by the converted data generation circuit 90. For example, when L is “1”, the data of the higher-order L bit is reversed in the positive period and the negative period. On the other hand, the data of the lower-order (K-L) bits is identical in the positive period and the negative period.

Therefore, in the DAC 58 which functions as a decoder that selects one grayscale voltage based on the converted grayscale data in each polarity period, the number of nodes of which the logic state is identical in the positive period and the negative period can be increased as compared with an all-bit inversion method which has been employed for polarity inversion drive. According to this embodiment, the signal path of the DAC 58 selected based on at least the data of the lower-order (K-L) bits can be made identical in the positive period and the negative period by generating the converted grayscale as shown in FIG. 5. As a result, current consumption caused by charging or discharging the nodes can be reduced.

FIG. 6 is a view illustrative of the operation of the converted data generation circuit 90 according to this embodiment when K is “4” and L is “1”.

FIG. 6 shows positive converted grayscale data (binary number representation) and negative converted grayscale data (binary number representation) corresponding to each grayscale value (decimal representation) indicated by the grayscale data. FIG. 6 also shows grayscale data (positive and negative) utilizing an all-bit inversion method which has been employed for polarity inversion drive as a comparative example.

When using the all-bit inversion method which has been employed for polarity inversion drive, all bits of the grayscale data are reversed in the positive period and the negative period. The positive grayscale data is the binary number representation of the grayscale value. The negative grayscale data is data obtained by reversing each bit of the positive grayscale data. Therefore, the code word distance between the grayscale data in the positive period and the grayscale data in the negative period is

On the other hand, when the data of the MSB of the grayscale data is “0” (second data in a broad sense), the converted data generation circuit 90 according to this embodiment outputs the grayscale data as the converted grayscale data without converting the grayscale data. When the data of the MSB of the grayscale data is “1” (first data in a broad sense), the converted data generation circuit 90 generates the converted grayscale data by converting the data of the lower-order 3 (=4-1) bits of the grayscale data so that the code word distance between the data of the lower-order 3 (=4-1) bits of the grayscale data before conversion and the data of the lower-order 3 (=4-1) bits of the grayscale data after conversion is 3 (=4-1). Specifically, when the data of the MSB is “1” and the data of the lower-order three bits is “000”, for example, the data of the lower-order three bits of the converted grayscale data is “110”. When the data of the MSB is “1” and the data of the lower-order three bits is “001”, the data of the lower-order three bits of the converted grayscale data is “110”. When the data of the MSB is “1” and the data of the lower-order three bits is “111”, the data of the lower-order three bits of the converted grayscale data is “000”. In the positive period, the source driver 30 drives the source line based on the grayscale signal corresponding to the converted grayscale data.

In the negative period, the source driver 30 drives the source line based on the grayscale signal corresponding to data obtained by converting the higher-order one bit (MSB) of the converted grayscale data so that the code word distance between the higher-order one (=L) bit (MSB) of the converted grayscale data before conversion and the higher-order one bit of the converted grayscale data after conversion is “1”.

In order to set the code word distance between one-bit data before conversion and the one-bit data after conversion at “1”, the bit must be reversed.

According to this embodiment, the negative converted grayscale data can be obtained 20 merely by reversing the higher-order one bit (MSB) irrespective of whether the higher-order one bit (MSB) is “0” or “1”.

According to this embodiment, the number of times that the data of the higher-order L bits of the converted grayscale data is converted is reduced as compared with the number of times that the data of the lower-order (K-L) bits of the converted grayscale data is converted in the positive drive period and the negative drive period by driving the source line based on the grayscale signal corresponding to the converted grayscale data read from the display RAM 52 (buffer) in the positive drive period, and driving the source line based on the grayscale signal corresponding to data obtained by converting the higher-order L bits of the converted grayscale data read from the display RAM 52 (buffer) in the negative drive period.

Therefore, it suffices to reverse only the MSB of the converted grayscale data during polarity inversion drive by converting the grayscale data into the converted grayscale data before storing the grayscale data in the display RAM 52 and storing the converted grayscale data in the display RAM 52. Specifically, the number of bit inversion circuits used for polarity inversion drive can be reduced as compared with the case of using the all-bit inversion method. Moreover, since the data of the lower-order three bits is not changed, the amount of charging or discharging of the DAC can be reduced.

When using the all-bit inversion method, since the code word distance between the positive period and the negative period is “K”, the signal path of the DAC 58 selected in the positive period differs from the signal path of the DAC 58 selected in the negative period.

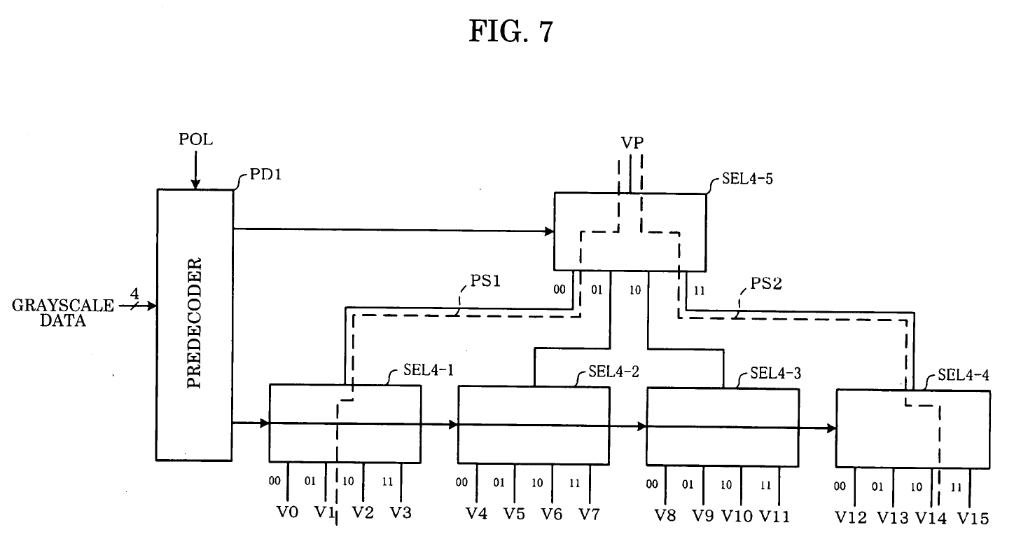

FIG. 7 shows an example of a signal path of a DAC having a tournament configuration selected based on grayscale data generated using the all-bit inversion method.

The DAC shown in FIG. 7 outputs one of grayscale voltages V0 to V15 as a selected voltage VP corresponding to four (=K) bit grayscale data. The DAC having a tournament configuration to which the four-bit grayscale data is input includes a plurality of four-input one-output selectors provided in two stages.

The first stage includes four-input one-output selectors SEL4-1 to SEL4-4. Each four-input one-output selector has an identical configuration, and outputs one selected voltage based on the data of the lower-order two bits of the grayscale data. A selection control signal input to each four-input one-output selector is generated by a predecoder PD1 to which the four-bit grayscale data and the polarity inversion signal POL are input. The grayscale voltages V0 to V3 are sequentially input to the four-input one-output selector SEL4-1. The grayscale voltages V4 to V7 are sequentially input to the four-input one-output selector SEL4-2. The grayscale voltages V8 to V11 are sequentially input to the four-input one-output selector SEL4-3. The grayscale voltages V12 to V15 are sequentially input to the four-input one-output selector SEL4-4.

The second stage includes a four-input one-output selectors SEL4-5. The four-input one-output selector SEL4-5 has the same configuration as that of the four-input one-output selector in the first stage. The four-input one-output selector SEL4-5 selects one of the selection outputs from the four-input one-output selectors SEL4-1 to SEL4-4 in the first stage based on the data of the higher-order two bits of the grayscale data. A selection control signal input to the four-input one-output selector SEL4-5 is generated by the predecoder PD1.

In FIG. 7, the number of bits of the grayscale data is four. When the number of bits of the grayscale data is six, the DAC having a tournament configuration has a three-stage configuration.

When using the all-bit inversion method, when the grayscale data is “0001”, a signal path PS1 is selected in the positive period, and a signal path PS2 is selected in the negative period, for example. Specifically, the grayscale voltage VI is selected in the positive period, and the grayscale voltage V14 is selected in the negative period. Therefore, when the code word distance is “4” (=K), the signal path of the DAC selected in the positive period differs from the signal path of the DAC selected in the negative period. As a result, the capacitive node in each signal path is repeatedly charged or discharged, whereby current consumption increases.

According to this embodiment, the signal path of the DAC 58 selected based on at least the data of the lower-order three (=4-1) bits can be made identical in the positive period and the negative period by generating the converted grayscale as shown in FIG. 5.

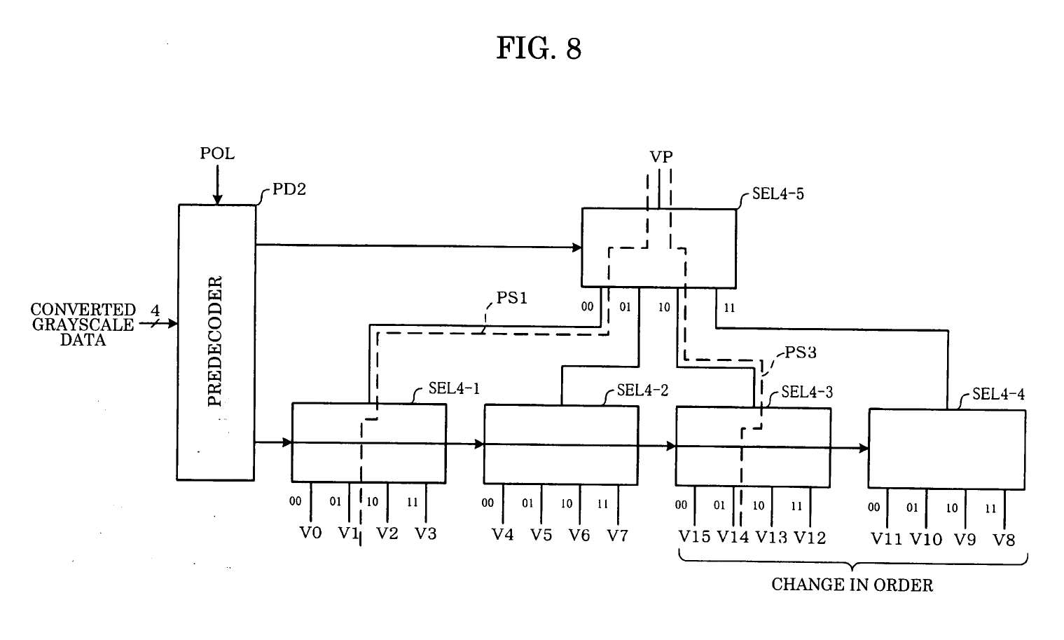

FIG. 8 shows an example of a signal path of the DAC 58 having a tournament configuration selected based on the converted grayscale data according to this embodiment.

In FIG. 8, the same sections as in FIG. 7 are indicated by the same symbols. Description of these sections is appropriately omitted.

The DAC 58 shown in FIG. 8 outputs one of the grayscale voltages VO to V15 as the selected voltage VP corresponding to four (=K) bit grayscale data. The DAC 58 having a tournament configuration to which the four-bit grayscale data is input includes a plurality of four-input one-output selectors provided in two stages.

The first stage includes four-input one-output selectors SEL4-1 to SEL4-4. Each four-input one-output selector has an identical configuration, and outputs one selected voltage based on the data of the lower-order two bits of the grayscale data. A selection control signal input to each four-input one-output selector is generated by a predecoder PD2 to which the four-bit grayscale data and the polarity inversion signal POL are input. The grayscale voltages V0 to V3 are sequentially input to the four-input one-output selector SEL4-1, and the grayscale voltages V4 to V7 are sequentially input to the four-input one-output selector SEL4-2. The grayscale voltages V15 to V12 are sequentially input to the four-input one-output selector SEL4-3, and the grayscale voltages V11 to V8 are sequentially input to the four-input one-output selector SEL4-4, differing from FIG. 7.

The second stage includes a four-input one-output selectors SEL4-5. The four-input one-output selector SEL4-5 has the same configuration as that of the four-input one-output selector in the first stage. The four-input one-output selector SEL4-5 selects one of the selection outputs from the four-input one-output selectors SEL4-1 to SEL4-4 in the first stage based on the data of the higher-order two bits of the grayscale data. A selection control signal input to the four-input one-output selector SEL4-5 is generated by the predecoder PD2.

In FIG. 8, the number of bits of the grayscale data is four. When the number of bits of the grayscale data is six, the DAC 58 having a tournament configuration has a three-stage configuration.

In this embodiment, when the grayscale data is “0001”, a signal path PSI is selected in the positive period, and a signal path PS3 is selected in the negative period, for example. Specifically, the grayscale voltage V1 is selected in the positive period, and the grayscale voltage V14 is selected in the negative period. Therefore, when the code word distance is “4” (=K), the signal path of the DAC 58 selected in the positive period differs from the signal path of the DAC 58 selected in the negative period in all of the four-input one-output selectors SEL4-1 to SEL4-4 in the first stage. Accordingly, each node of the four-input one-output selectors in the first stage need not be charged or discharged in the positive period and the negative period as long as an identical grayscale is displayed, whereby current consumption can be reduced as compared with the case of using the all-bit inversion method. Since current consumption is thus reduced corresponding to each source output each time the polarity is reversed, the current consumption of the entire source driver 30 can be significantly reduced.

Although the DAC 58 shown in FIG. 8 has a tournament configuration, the DAC 58 may have a full-decode configuration. A person skilled in the art would appreciate that current consumption can be reduced as compared with the case of using the all-bit inversion method as long as the code word distance of the full-decode input target data is smaller than “K”.

Although FIGS. 6 to 8 show an example in which L is “1”, L may be a value that satisfies 2≦L≦K.

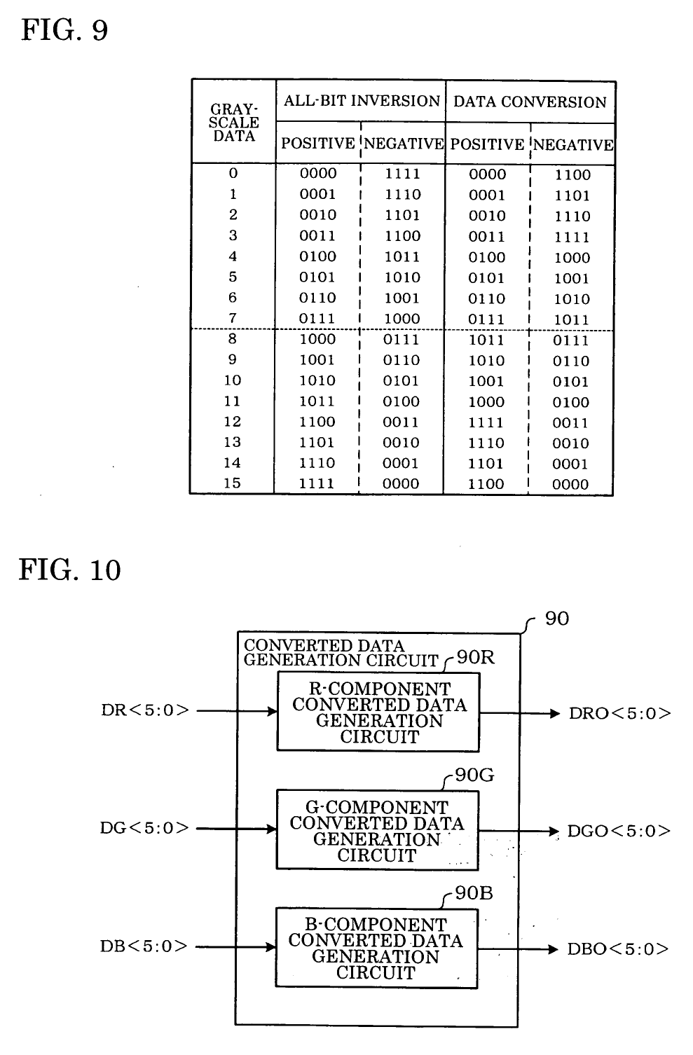

FIG. 9 is a view illustrative of the operation of the converted data generation circuit 90 according to this embodiment when K is “4” and L is “2”.

FIG. 9 shows positive converted grayscale data (binary number representation) and negative converted grayscale data (binary number representation) corresponding to each grayscale value (decimal representation) indicated by the grayscale data. FIG. 9 also shows grayscale data (positive and negative) utilizing the all-bit inversion method which has been employed for polarity inversion drive as a comparative example.

When the data of the MSB of the grayscale data is “0” (second data in a broad sense), the converted data generation circuit 90 according to this embodiment outputs the grayscale data as the converted grayscale data without converting the grayscale data. When the data of the MSB of the grayscale data is “1” (first data in a broad sense), the converted data generation circuit 90 generates the converted grayscale data by converting the data of the lower-order two (=4-2) bits of the grayscale data so that the code word distance between the data of the lower-order two (=4-2) bits of the grayscale data before conversion and the data of the lower-order two (=4-2) bits of the grayscale data after conversion is two (=(4-2)≦3). For example, when the data of the MSB is “1” and the data of the lower-order two bits is “00”, the data of the lower-order two bits of the converted grayscale data is “11”. When the data of the MSB is “1” and the data of the lower-order two bits is “01”, the data of the lower-order two bits of the converted grayscale data is “10”. When the data of the MSB is “1” and the data of the lower-order two bits is “11”, the data of the lower-order two bits of the converted grayscale data is “00”.

In the negative period, the source driver 30 drives the source line based on the grayscale signal corresponding to data obtained by converting the higher-order two bits (MSB) of the converted grayscale data so that the code word distance between the higher-order two (=L) bits (MSB) of the converted grayscale data before conversion and the higher-order two bits of the converted grayscale data after conversion is “2”. Note that the code word distance is not limited to “2”. The source driver 30 may drive the source line based on the grayscale signal corresponding to data obtained by converting the higher-order two bits (MSB) of the converted grayscale data so that the code word distance is “1”.

In order to set the code word distance between two-bit data before conversion and the two-bit data after conversion at “1”, the bit must be reversed. According to this embodiment, the negative converted grayscale data can be obtained merely by reversing the higher-order two bits of the converted grayscale data.

The DAC 58 may also have a tournament configuration in the same manner as in FIG. 8 even when L is “2”. For example, the grayscale voltages V11 to V8 are sequentially input to the four-input one-output selector SEL4-3, and the grayscale voltages V15 to V12 are sequentially input to the four-input one-output selector SEL4-4, differing from FIG. 8.

Therefore, at least one of the four-input one-output selectors in the first stage can maintain an identical signal path in the positive period and the negative period. Accordingly, since the amount of charging or discharging of each node of the four-input one-output selectors in the first stage can be reduced as compared with the case of using the all-bit inversion method as long as an identical grayscale is displayed, current consumption can be reduced.

In this embodiment, since the code word distance is minimized when L is “1”, the number of nodes which are charged or discharged in the positive period and the negative period can be minimized so that the effect of reducing power consumption becomes a maximum. Therefore, it is desirable that L be “1”.

Although FIGS. 6 to 9 show an example in which K is “4”, K may be another value.

2.3 Configuration Example

A configuration example of the main portion of the source driver 30 shown in FIG. 4 is described below. The following description is given on the assumption that the number of bits of the grayscale data of each of the RGB color components is “6” (=K) and the number of higher-order-bits is “1” (=L).

2.3.1 Converted data generation circuit

FIG. 10 shows an outline of the configuration of the converted data generation circuit 90 shown in FIG. 4.

The converted data generation circuit 90 includes an R-component converted data generation circuit 90R, a G-component converted data generation circuit 90G, and a B-component converted data generation circuit 90B. Each converted data generation circuit has an identical configuration.

R-component six-bit grayscale data DR<5:0>is input to the R-component converted data generation circuit 90R. The R-component converted data generation circuit 90R outputs six-bit converted grayscale data DRO<5:0>. G-component six-bit grayscale data DG<5:0>is input to the G-component converted data generation circuit 90G The G-component converted data generation circuit 90G outputs six-bit converted grayscale data DGO<5:0>. B-component six-bit grayscale data DB<5:0>is input to the B-component converted data generation circuit 90B. The B-component converted data generation circuit 90B outputs six-bit converted grayscale data DBO<5:0>. Specifically, the converted data generation circuit 90 converts the grayscale data into the converted grayscale data corresponding to each color component.

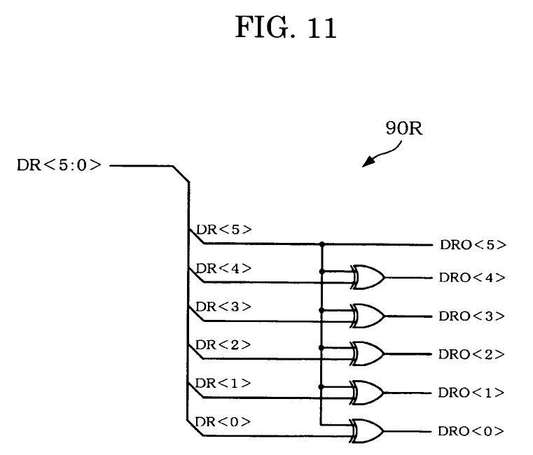

FIG. 11 is a circuit diagram showing a configuration example of the R-component converted data generation circuit 90R shown in FIG. 10.

Note that the G-component converted data generation circuit 90G and the B-component converted data generation circuit 90B have the same configuration as the R-component converted data generation circuit 90R shown in FIG. 11.

In the R-component converted data generation circuit 90R, data DR<5>that is the data of the MSB of the R-component grayscale data DR<5:0>is input to exclusive OR (EXOR) circuits provided corresponding to the bits of the data DR<4:0>. The data DR<4:0>is output as the converted grayscale data DRO<4:0>when the data DR<5>is “0”, and the bit-inverted data of the data DR<4:0>is output as the converted grayscale data DRO<4:0>when the data DR<5>is “1”. The data DR<5>is output as the converted grayscale data DRO<5>.

The positive converted grayscale data shown in FIG. 6 is thus generated and stored in the display RAM 52.

2.3.2 DAC

The DAC 58 shown in FIG. 4 includes decoders corresponding to the source outputs. The DAC 58 may have the following tournament configuration aimed at reducing the impedance of the grayscale voltage selection path and achieving an efficient layout.

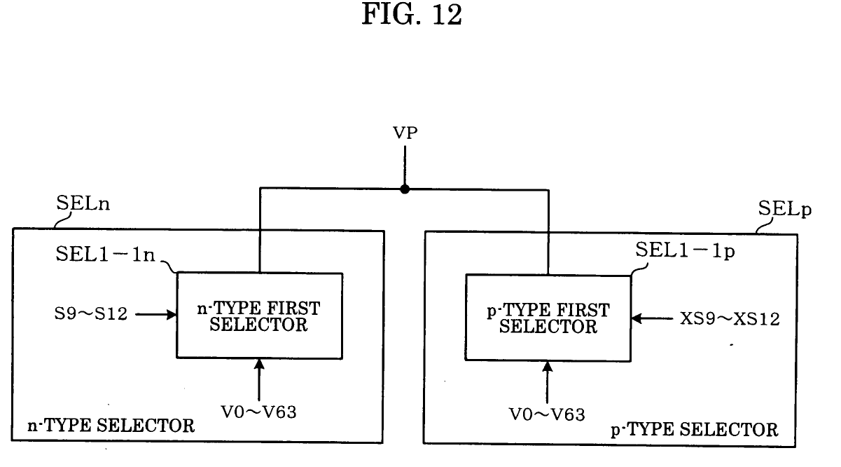

FIG. 12 shows a configuration example of the decoder included in the DAC 58 shown in FIG. 4.

The decoder shown in FIG. 12 operates based on the data of the higher-order a bits of (a+b+c) (a, b, and c are positive integers) bit converted grayscale data (digital data), and electrically connects a grayscale voltage signal line (generated voltage signal line), to which one of a plurality of grayscale voltages (generated voltage) selected corresponding to the data of the lower-order (b+c) bits of the converted grayscale data is supplied, with the input of the output circuit based on the data of the higher-order a bits of the (a+b+c)-bit converted grayscale data. The following description is given on the assumption that a is “2”, b is “2”, and c is “2”.

The decoder includes a p-type selector SELp and an n-type selector SELn. The p-type selector SELp includes a transmission gate that includes only p-type metal-oxide-semiconductor (MOS) transistors. The n-type selector SELn includes a transmission gate that includes only n-type MOS transistors.

When the p-type is referred to as a first conductivity type, the n-type may be referred to as a second conductivity type. When the n-type is referred to as a first conductivity type, the p-type may be referred to as a second conductivity type. This also applies to the following description.

The p-type selector SELp and the n-type selector SELn have a complementary relationship. Specifically, a decrease in voltage corresponding to the threshold voltage of the n-type MOS transistor which occurs in the transmission gate that includes only the n-type MOS transistors is compensated for by the output of the transmission gate that includes only the p-type MOS transistors. A decrease in voltage corresponding to the threshold voltage of the p-type MOS transistor which occurs in the transmission gate that includes only the p-type MOS transistors is compensated for by the output of the transmission gate that includes only the n-type MOS transistors.

The p-type selector SELp includes a p-type first selector SEL1-1p. The n-type selector SELn includes an n-type first selector SEL1-1n.

The p-type first selector SEL1-1p includes a plurality of p-type MOS transistors, gate signals corresponding to the data of the a bits of the converted grayscale data being supplied to the gates of the p-type MOS transistors, and the drains of the p-type MOS transistors being electrically connected. In FIG. 12 (a=2), gate signals XS9 to XS12 are supplied to the gates of the p-type MOS transistors.

The n-type first selector SEL1-1n includes a plurality of n-type MOS transistors, gate signals corresponding to the data of the a bits of the converted grayscale data being supplied to the gates of the n-type MOS transistors, and the drains of the n-type MOS transistors being electrically connected. In FIG. 12, gate signals S9 to S12 are supplied to the gates of the n-type MOS transistors.

A connection node of the drains of the p-type MOS transistors included in the p-type first selector SEL1-1p is electrically connected to a connection node of the drains of the n-type MOS transistors included in the n-type first selector SEL1-1n.

In the decoder, grayscale voltages selected corresponding to the data of the (b+c) bits of the converted grayscale data are supplied to the source of each of the MOS transistors included in the first selectors SEL1-1p and SEL1-1n. In FIG. 12, four grayscale voltages among a plurality of grayscale voltages V0 to V63 selected corresponding to the lower-order four bits of the converted grayscale data are input to the first selectors SEL1-1p and SEL1-1n.

In this embodiment, the gate signal (S9 to S12 and XS9 to XS12 in FIG. 12) supplied to each MOS transistor is generated by a predecoder.

The decoder having the above-described configuration allows a reduction in the number of transistors provided in the electrical paths for the grayscale voltages selected by the first selectors SEL1-1p and SEL1-1n.

A detailed configuration example of the decoder shown in FIG. 12 is described below.

The predecoder is described below.

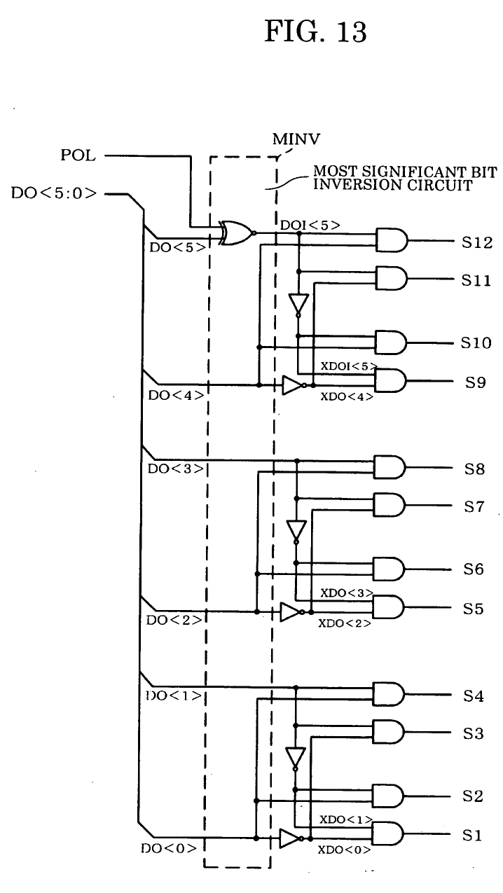

FIG. 13 shows a configuration example of the predecoder.

The predecoder is provided in each decoder. The most significant bit of the six-bit converted grayscale data DO<5>to DO<0>is the data DO<5>, and the least significant bit of the six-bit converted grayscale data DO<5>to DO<0>is the data DO<0>. When one bit of the converted grayscale data is referred to as DO<x>(0≦x≦5, x is an integer), data XDO<x>is the inverted data of the data DO<x>.

The predecoder includes a most significant bit inversion circuit MINV that reverses only the most significant bit of the converted grayscale data in the negative (second polarity) drive period. The most significant bit inversion circuit MINV reverses only the converted grayscale data DO<5>contained in the converted grayscale data DO<5:0>when the polarity inversion signal POL is set at the L level, and outputs converted grayscale data DOI<5>.

The predecoder generates the gate signals S1 to S12. The predecoder generates the gate signals S9 to S12 based on the data of the higher-order two (a=2) bits of the converted grayscale data. Specifically, the predecoder generates the gate signals S9 to S12 based on the data DOI<5>output from the most significant bit inversion circuit, the converted grayscale data DO<4>, inverted data XDOI<5>, and inverted data XD<5>.

The converted grayscale data DO<3>to DO<0>may be referred to as the data of the lower-order four bits of the converted grayscale data with respect to the converted grayscale data DO<5>(DOI<5>) and DO<4>. In this embodiment, the lower-order four bits are classified into medium-order two bits and lower-order two bits with respect to the medium-order two bits.

The predecoder generates the gate signals S5 to S8 based on the data of the medium-order two (b=2) bits of the converted grayscale data. Specifically, the predecoder generates the gate signals S5 to S8 based on the data DO<2>and DO<3>of the medium-order two bits of the converted grayscale data and inverted data XDO<3>and XDO<2>.

The predecoder generates the gate signals SI to S4 based on the data of the lower-order two (c=2) bits of the converted grayscale data. Specifically, the predecoder generates the gate signals S1 to S4 based on the data DO<1>and DO<0>of the lower-order two bits of the converted grayscale data and inverted data XDO<1>and XDO<0>.

The gate signals XS1 to XS12 are generated by reversing the gate signals S1 to S12, respectively. The gate signals XS1 to XS12 are generated by the predecoder shown in FIG. 13.

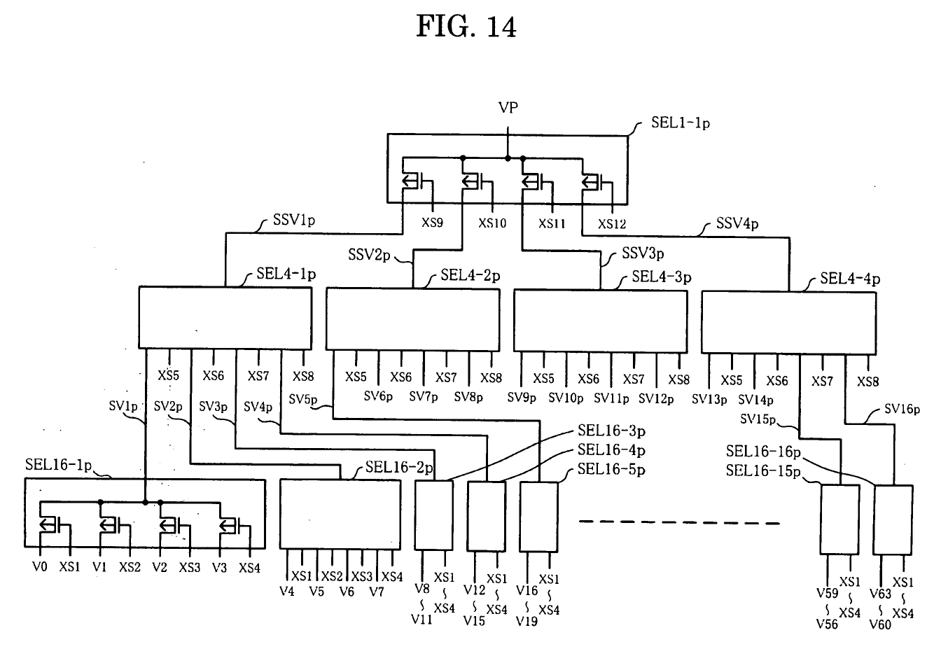

FIG. 14 shows a configuration example of the p-type selector SELp shown in FIG. 12.

As shown in FIG. 14, the p-type first selector SEL1-1p includes a plurality of p-type MOS transistors, the gate signals XS9 to XS12 corresponding to the data of the higher-order two (=a) bits of the converted grayscale data being supplied to the gates of the p-type MOS transistors, and the drains of the p-type MOS transistors being electrically connected. The voltage at a connection node of the drains of the p-type MOS transistors is input to the operational amplifier of the output circuit of the source line driver circuit as the grayscale voltage VP.

The p-type selector SELp includes four (=22) p-type second selectors SEL4-1p to SEL4-4p. Each second selector has the same configuration as that of the p-type first selector SEL1-1p.

Each of the p-type second selectors SEL4-1p to SEL4-4p includes a plurality of p-type MOS transistors, the gate signals XS5 to XS8 corresponding to the data of the medium-order two (=b) bits of the converted grayscale data being supplied to the gates of the p-type MOS transistors, and the drains of the p-type MOS transistors being electrically connected. A node connected to the drains of the p-type MOS transistors is electrically connected to the source of one of the p-type MOS transistors included in the p-type first selector SEL1-1p.

The p-type selector SELp further includes sixteen (=2²⁺²) p-type third selectors SEL16-1p to SEL16-16p. Each third selector has the same configuration as that of the p-type first selector SEL1-1p.

Each of the p-type third selectors SEL16-1p to SEL16-16p includes a plurality of p-type MOS transistors, the gate signals XS1 to XS4 corresponding to the data of the lower-order two (=c) bits of the converted grayscale data being supplied to the gates of the p-type MOS transistors, and the drains of the p-type MOS transistors being electrically connected. A node connected to the drains of the p-type MOS transistors is electrically connected to the source of one of the p-type MOS transistors included in the p-type second selectors SEL4-1p to SEL4-4p.

Specifically, the connection nodes of the p-type third selectors SEL16-1p to SEL16-4p are electrically connected to the sources of the corresponding p-type MOS transistors included in the p-type second selector SEL4-1p. The connection nodes of the p-type third selectors SEL16-5p to SEL16-8p are electrically connected to the sources of the corresponding p-type MOS transistors included in the p-type second selector SEL4-2p. The connection nodes of the p-type third selectors SEL16-9p to SEL16-12p are electrically connected to the sources of the corresponding p-type MOS transistors included in the p-type second selector SEL4-3p. The connection nodes of the p-type third selectors SEL16-13p to SEL16-16p are electrically connected to the sources of the corresponding p-type MOS transistors included in the p-type second selector SEL4-4p.

The grayscale voltages V0 to V3 are respectively supplied to the sources of the p-type MOS transistors included in the p-type third selector SEL16-1p. The grayscale voltages V4 to V7 are respectively supplied to the sources of the p-type MOS transistors included in the p-type third selector SEL16-2p. The grayscale voltages shown in FIG. 14 are supplied to the sources of the p-type MOS transistors included in the remaining p-type third selectors.

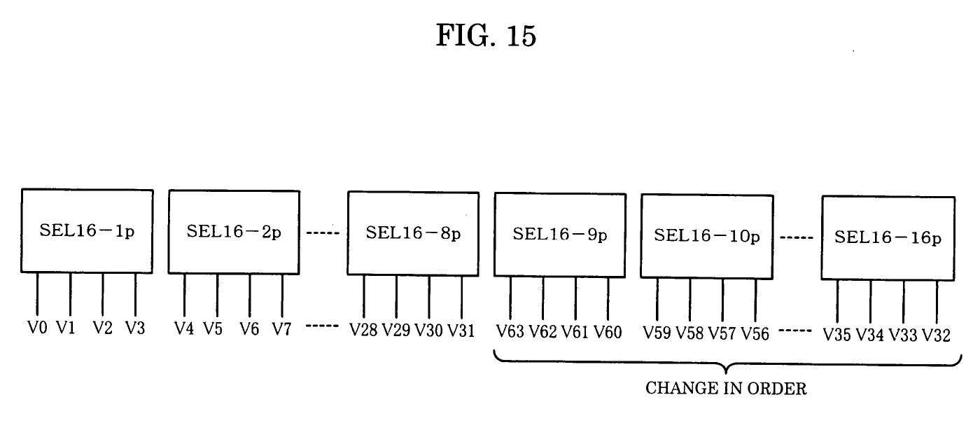

FIG. 15 is a view illustrative of the grayscale voltages supplied to each p-type third selector shown in FIG. 14.

The p-type third selectors SEL16-1p to SEL16-16p shown in FIG. 14 have an identical configuration. The grayscale voltages V0 to V3 are supplied to the input terminals of the p-type third selector SEL16-1p in grayscale potential descending order (or ascending order). The grayscale voltages V4 to V7 are supplied to the input terminals of the p-type third selector SEL16-2p in grayscale potential descending order (or ascending order). This also applies to the p-type third selectors SEL16-3p to SEL16-8p.

On the other hand, the grayscale voltages V63 to V60 are supplied to the input terminals of the p-type third selector SEL16-9p in grayscale potential ascending order (or descending order), and the grayscale voltages V59 to V56 are supplied to the input terminals of the p-type third selector SEL16-10p in grayscale potential ascending order (or descending order), differing from the p-type third selectors SEL16-1p to SEL16-8p. This also applies to the p-type third selectors SEL16-11p to SEL16-16p. When using the all-bit inversion method, the grayscale voltages are uniformly supplied to the p-type third selectors SEL16-1p to SEL16-16p of the DAC having a tournament configuration in potential descending or ascending order. In FIG. 14, the grayscale voltages are supplied to the p-type third selectors SEL16-1p to SEL16-8p and the p-type third selectors SEL16-9p to SEL16-16p in reverse order corresponding to the converted grayscale data shown in FIG. 6.

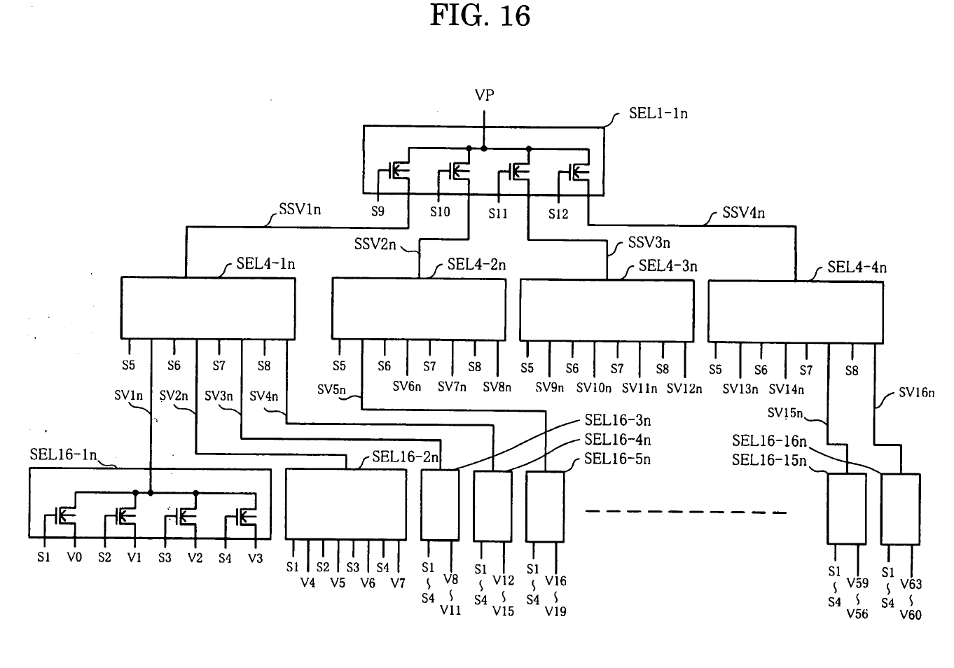

FIG. 16 shows a configuration example of the n-type selector SELn shown in FIG. 12.

As shown in FIG. 16, the n-type first selector SEL1-1n includes a plurality of n-type MOS transistors, the gate signals S9 to S12 corresponding to the data of the higher-order two (=a) bits of the converted grayscale data being supplied to the gates of the n-type MOS transistors, and the drains of the n-type MOS transistors being electrically connected. The voltage at a connection node of the drains of the n-type MOS transistors is input to the operational amplifier of the output circuit of the source line driver circuit as the grayscale voltage VP.

The n-type selector SELn includes four (=2²) n-type second selectors SEL4-1n to SEL4-4n. Each second selector has the same configuration as that of the n-type first selector SEL1-1n.

Each of the n-type second selectors SEL4-1n to SEL4-4n includes a plurality of n-type MOS transistors, the gate signals S5 to S8 corresponding to the data of the medium-order two (=b) bits of the converted grayscale data being supplied to the gates of the n-type MOS transistors, and the drains of the n-type MOS transistors being electrically connected. A node connected to the drains of the n-type MOS transistors is electrically connected to the source of one of the n-type MOS transistors included in the n-type first selector SEL1-1n.

The n-type selector SELn further includes sixteen (=2²⁺²) n-type third selectors SEL16-1n to SEL16-16n. Each third selector has the same configuration as that of the n-type first selector SEL1-1n.

Each of the n-type third selectors SEL16-1n to SEL16-16n includes a plurality of p-type MOS transistors, the gate signals S1 to S4 corresponding to the data of the lower-order two (=c) bits of the converted grayscale data being supplied to the gates of the n-type MOS transistors, and the drains of the n-type MOS transistors being electrically connected. A node connected to the drains of the n-type MOS transistors is electrically connected to the source of one of the n-type MOS transistors included in the n-type second selectors SEL4-1n to SEL4-4n.

Specifically, the connection nodes of the n-type third selectors SEL16-1n to SEL16-4n are electrically connected to the sources of the corresponding n-type MOS transistors included in the n-type second selector SEL4-1n. The connection nodes of the n-type third selectors SEL16-5n to SEL16-8n are electrically connected to the sources of the corresponding n-type MOS transistors included in the n-type second selector SEL4-2n. The connection nodes of the n-type third selectors SEL16-9n to SEL16-12n are electrically connected to the sources of the corresponding n-type MOS transistors included in the n-type second selector SEL4-3n. The connection nodes of the n-type third selectors SEL16-13n to SEL16-16n are electrically connected to the sources of the corresponding n-type MOS transistors included in the n-type second selector SEL4-4n.

The grayscale voltages V0 to V3 are respectively supplied to the sources of the n-type MOS transistors included in the n-type third selector SEL16-1n. The grayscale voltages V4 to V7 are respectively supplied to the sources of the n-type MOS transistors included in the n-type third selector SEL16-2n. The grayscale voltages shown in FIG. 16 are supplied to the sources of the n-type MOS transistors included in the remaining n-type third selectors.

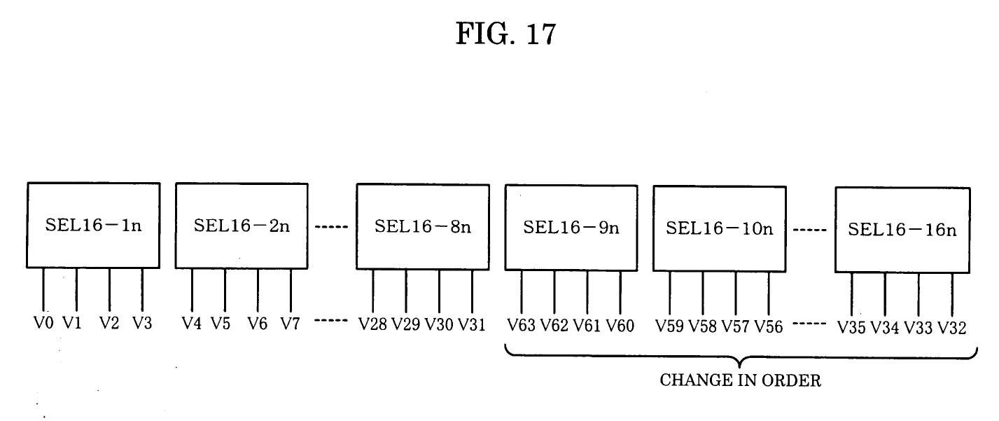

FIG. 17 is a view illustrative of the grayscale voltages supplied to each n-type third selector shown in FIG. 16.

The n-type third selectors SEL16-1n to SEL16-16n shown in FIG. 16 have an identical configuration. The grayscale voltages V0 to V3 are supplied to the input terminals of the n-type third selector SEL16-1n in grayscale potential descending order (or ascending order). The grayscale voltages V4 to V7 are supplied to the input terminals of the n-type third selector SEL16-2n in grayscale potential descending order (or ascending order). This also applies to the n-type third selectors SEL16-3n to SEL16-8n.

On the other hand, the grayscale voltages V63 to V60 are supplied to the input terminals of the n-type third selector SEL16-9n in grayscale potential ascending order (or descending order), and the grayscale voltages V59 to V56 are supplied to the input terminals of the n-type third selector SEL16-10n in grayscale potential ascending order (or descending order), differing from the n-type third selectors SEL16-1n to SEL16-8n. This also applies to the n-type third selectors SEL16-11n to SEL16-16n. When using the all-bit inversion method, the grayscale voltages are uniformly supplied to the n-type third selectors SEL16-1n to SEL16-16n of the DAC having a tournament configuration in potential descending or ascending order. In FIG. 16, the grayscale voltages are supplied to the n-type third selectors SEL16-1n to SEL16-8n and the n-type third selectors SEL16-9n to SEL16-16n in reverse order corresponding to the converted grayscale data shown in FIG. 6.

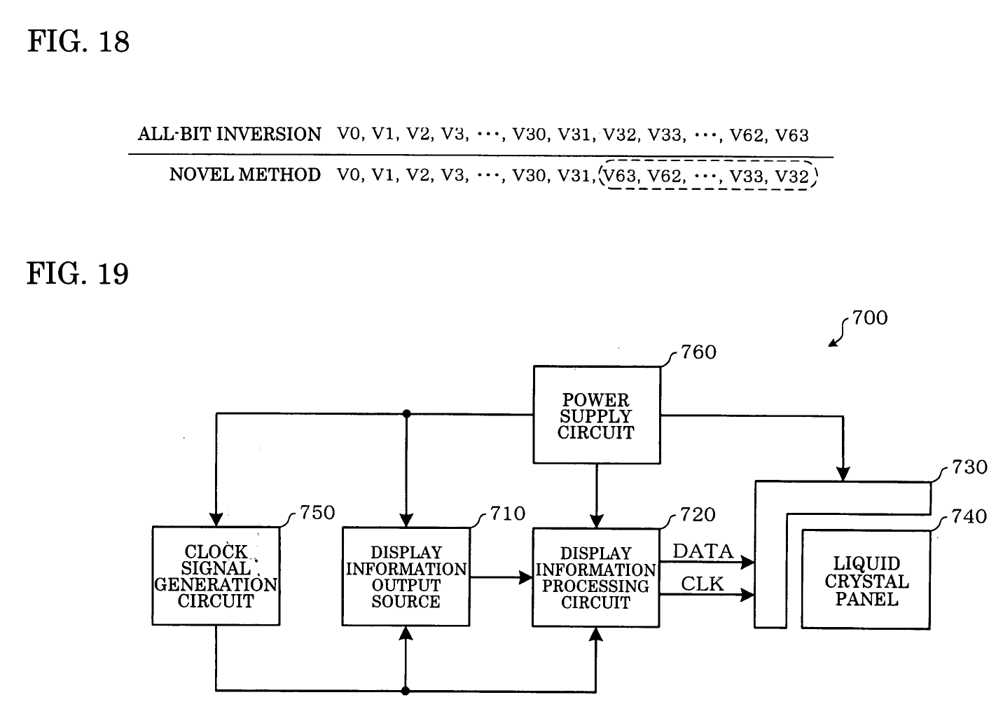

FIG. 18 shows a comparison between a grayscale voltage supply example according to this embodiment and a grayscale voltage supply example when using the all-bit inversion method.

As shown in FIG. 18, when forming a DAC having a tournament configuration using the all-bit inversion method, the grayscale voltages V0 to V63 are input to the input terminals of the selectors shown in FIG. 14 or 16 in potential ascending order (or descending order). In this embodiment, the selectors to which the grayscale voltages V32 to V63 are input are changed by changing the wiring configuration, and the grayscale voltages V32 to V63 are supplied in potential descending order (or ascending order).

A DAC that can significantly reduce power consumption can be provided with a small design change so that the cost of the source driver 30 including the DAC can be reduced.

3. Electronic Instrument

An electronic instrument to which the liquid crystal device 10 (source driver 30) according to the above embodiment is applied is described below.

3.1 Projection-type Display Device

An electronic instrument formed using the liquid crystal device 10 may be a projection-type display device.

FIG. 19 is a block diagram showing a configuration example of a projection-type display device to which the liquid crystal device 10 according to the above embodiment is applied.

A projection-type display device 700 includes a display information output source 710, a display information processing circuit 720, a display driver circuit 730 (display driver), a liquid crystal panel 740, a clock signal generation circuit 750, and a power supply circuit 760. The display information output source 710 includes a memory such as a read only memory (ROM), a random access memory (RAM), or an optical disk device, and a tuning circuit which tunes and outputs an image signal. The display information output source 710 outputs display information (e.g., image signal in a given format) to the display information processing circuit 720 based on a clock signal from the clock signal generation circuit 750. The display information processing circuit 720 may include an amplification/polarity inversion circuit, a phase expansion circuit, a rotation circuit, a gamma correction circuit, a clamping circuit, and the like. The display driver circuit 730 includes a gate driver and a source driver. The display driver circuit 730 drives the liquid crystal panel 740. The power supply circuit 760 supplies power to each circuit.

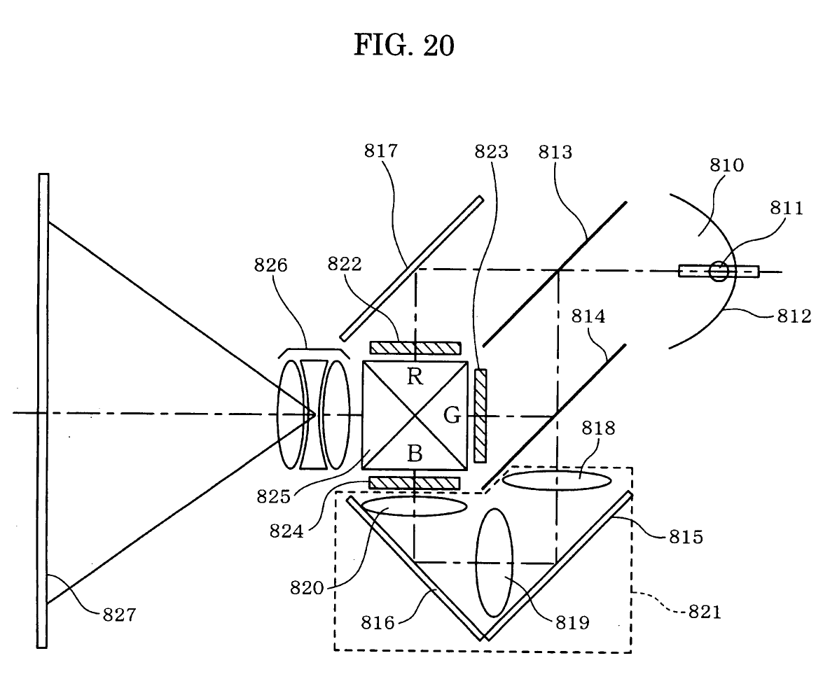

FIG. 20 is a schematic view showing the main portion of the projection-type display device.

The projection-type display device includes a light source 810, dichroic mirrors 813 and 814, reflection mirrors 815, 816, and 817, an incident lens 818, a relay lens 819, an exit lens 820, liquid crystal light modulators 822, 823, and 824, a cross dichroic prism 825, and a projection lens 826. The light source 810 includes a lamp 811 (e.g., metal halide lamp), and a reflector 812 that reflects light emitted from the lamp. The dichroic mirror 813 that reflects blue/green light allows red light contained in a beam from the light source 810 to pass through, and reflects blue light and green light. Red light that has passed through the dichroic mirror 813 is reflected by the reflection mirror 817, and enters the red light liquid crystal light modulator 822. Green light reflected by the dichroic mirror 813 is reflected by the dichroic mirror 814 that reflects green light, and enters the green light liquid crystal light modulator 823. Blue light also passes through the second dichroic mirror 814. A photo-conductive means 821 formed of a relay lens system including the incident lens 818, the relay lens 819, and the exit lens 820 is provided for blue light in order to prevent optical loss due to a long optical path. Blue light enters the blue light liquid crystal light modulator 824 through the photo-conductive means 821. The three color light rays modulated by each light modulator circuit enter the cross dichroic prism 825. Four rectangular prisms are bonded in the cross dichroic prism 825, and a dielectric multilayer film that reflects red light and a dielectric multilayer film that reflects blue light are formed on the inner side in the shape of a cross. The three color light rays are synthesized by the dielectric multilayer films so that light that represents a color image is formed. The projection means of the projection-type display device is formed as described above. Light synthesized by the projection means is projected onto a screen 827 by a projection lens 826 (projection optical system) so that an enlarged image is displayed.

3.2 Portable Telephone

An electronic instrument formed using the liquid crystal device 10 may be a portable telephone.

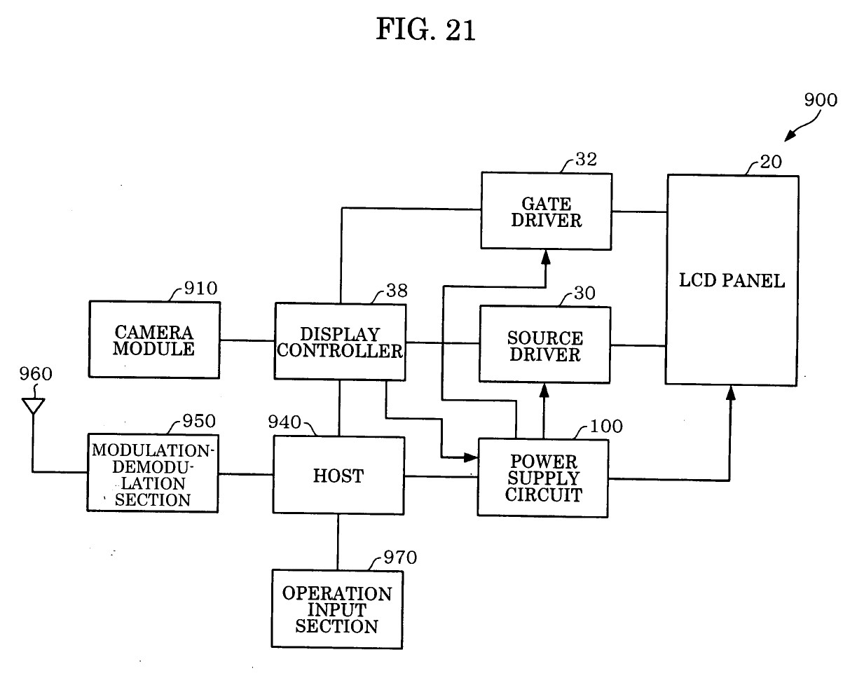

FIG. 21 is a block diagram showing a configuration example of a portable telephone to which the liquid crystal device 10 according to the above embodiment is applied. In FIG. 21, the same sections as in FIG. 1 or 2 are indicated by the same symbols. Description of these sections is appropriately omitted.

A portable telephone 900 includes a camera module 910. The camera module 910 includes a CCD camera, and supplies data relating to an image captured using the CCD camera to a display controller 38 in a YUV format.

The portable telephone 900 includes an LCD panel 20. The LCD panel 20 is driven by a source driver 30 and a gate driver 32. The LCD panel 20 includes a plurality of gate lines, a plurality of source lines, and a plurality of pixels.

The display controller 38 is connected to the source driver 30 and the gate driver 32, and supplies grayscale data in an RGB format to the source driver 30.

A power supply circuit 100 is connected to the source driver 30 and the gate driver 32, and supplies drive power supply voltages to the source driver 30 and the gate driver 32. The power supply circuit 100 supplies the common electrode voltage Vcom to the common electrode of the LCD panel 20.

A host 940 is connected to the display controller 38. The host 940 controls the display controller 38. The host 940 demodulates grayscale data received through an antenna 960 using a modulation-demodulation section 950, and supplies the demodulated grayscale data to the display controller 38. The display controller 38 causes the source driver 30 and the gate driver 32 to display an image on the LCD panel 20 based on the grayscale data.

The host 940 modulates grayscale data generated by the camera module 910 using the modulation-demodulation section 950, and instructs transmission of the modulated data to another communication device via the antenna 960.

The host 940 transmits and receives grayscale data, captures an image using the camera module 910, and displays an image on the LCD panel 20 based on operation information from an operation input section 970.

In FIG. 21, the host 940 or the display controller 38 may be referred to as a means that supplies the grayscale data.

The invention is not limited to the above-described embodiments. Various modifications and variations may be made without departing from the spirit and scope of the invention. For example, the invention may be applied not only to drive the liquid crystal display panel, but also to drive an electroluminescence display device, a plasma display device, and the like.

The above embodiments have been described taking an example in which the source driver 30 includes the converted data generation circuit 90. Note that the invention is not limited thereto. The host (not shown) or the display controller 38 may include the converted data generation circuit 90.

Some of the requirements of any claim of the invention may be omitted from a dependent claim that depends on that claim. Some of the requirements of any independent claim of the invention may be allowed to depend on any other independent claim.

Although only some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention.

What is claimed is:

1. A method of driving an electro-optical device that drives a source line of the electro-optical device that has an electro-optical element based on K-bit (K is an integer equal to or larger than two) grayscale data, the method comprising:
when data of a most significant bit of the grayscale data is first data, generating converted grayscale data by converting data of lower-order (K-L) bits (K>L, L is a positive integer) of the grayscale data so that a code word distance between the data of the lower-order (K-L) bits of the grayscale data before conversion and the data of the lower-order (K-L) bits of the grayscale data after conversion is equal to or less than (K-L); and
driving the source line based on a grayscale signal corresponding to the converted data in a first polarity drive period when a signal applied to the electro-optical element has a first polarity, and driving the source line based on a grayscale signal corresponding to data obtained by converting higher-order L bits of the converted data so that a code word distance between data of the higher-order L bits of the converted data before conversion and the data of the higher-order L bits of the converted data after conversion is equal to or less than L in a second polarity drive period when the signal applied to the electro-optical element has a second polarity.

2. The method of driving an electro-optical device as defined in claim 1, the method including:
storing the converted data in a buffer;
driving the source line based on a grayscale signal corresponding to the converted data read from the buffer in the first polarity drive period; and
driving the source line based on a grayscale signal corresponding to data obtained by converting the higher-order L bits of the converted data read from the buffer so that a code word distance between data of the higher-order L bits of the converted data before conversion and the data of the higher-order L bits of the converted data after conversion is equal to or less than L in the second polarity drive period.

3. A method of driving an electro-optical device that drives a source line of the electro-optical device that has an electro-optical element based on K-bit (K is an integer equal to or larger than two) grayscale data, the method comprising:
generating converted grayscale data by converting data of lower-order (K-L) bits (K>L, L is a positive integer) of the grayscale data, and storing the converted data in a buffer; and
driving the source line based on a grayscale signal corresponding to the converted data read from the buffer in a first polarity drive period when a signal applied to the electro-optical element has a first polarity, and driving the source line based on a grayscale signal corresponding to data obtained by converting higher-order L bits of the converted data read from the buffer in a second polarity drive period when the signal applied to the electro-optical element has a second polarity, so that the number of times that the data of the higher-order L bits of the converted grayscale data is converted is reduced as compared with the number of times that the data of the lower-order (K-L) bits of the converted grayscale data is converted in the first polarity drive period and the second polarity drive period.

4. The method of driving an electro-optical device as defined in claim 1, L being one.

5. A source driver that drives a source line of an electro-optical device that has an electro-optical element based on K-bit (K is an integer equal to or larger than two) grayscale data, the source driver comprising:
a converted data generation circuit, when data of a most significant bit of the grayscale data is first data, the converted data generation circuit generating converted grayscale data by converting data of lower-order (K-L) bits (K>L, L is a positive integer) of the grayscale data so that a code word distance between the data of the lower-order (K-L) bits of the grayscale data before conversion and the data of the lower-order (K-L) bits of the grayscale data after conversion is equal to or less than (K-L); and
a source line driver circuit that drives the source line based on a grayscale signal corresponding to the converted data in a first polarity drive period when a signal applied to the electro-optical element has a first polarity, and drives the source line based on a grayscale signal corresponding to data obtained by converting higher-order L bits of the converted data so that a code word distance between data of the higher-order L bits of the converted data before conversion and the data of the higher-order L bits of the converted data after conversion is equal to or less than L in a second polarity drive period when the signal applied to the electro-optical element has a second polarity.

6. The source driver as defined in claim 5,
the source driver further including a buffer that stores the converted data,
the source line driver circuit driving the source line based on a grayscale signal corresponding to the converted data read from the buffer in the first polarity drive period, and driving the source line based on a grayscale signal corresponding to data obtained by converting the higher-order L bits of the converted data read from the buffer so that so that a code word distance between data of the higher-order L bits of the converted data before conversion and the data of the higher-order L bits of the converted data after conversion is equal to or less than L in the second polarity drive period.

7. The source driver as defined in claim 5, L being one.

8. The source driver as defined in claim 7,
the source line driver circuit including a most significant bit inversion circuit that reverses only the most significant bit of the converted grayscale data in the second polarity drive period.

9. An electro-optical device comprising:
a plurality of gate lines;
a plurality of source lines;
a plurality of pixels, each of the plurality of pixels being specified by a corresponding gate line among the plurality of gate lines and a corresponding source line among the plurality of source lines;
a gate driver that scans the plurality of gate lines; and
the source driver as defined in claim 5 that drives the plurality of source lines.

10. An electro-optical device comprising the source driver as defined in claim 5.

11. A projection-type display device comprising:
the electro-optical device as defined in claim 9;
a light source that emits light that enters the electro-optical device; and
projection means that projects light emitted from the electro-optical device.

12. A projection-type display device comprising the source driver as defined in claim 5.

13. An electronic instrument comprising the electro-optical device as defined in claim 9.

14. An electronic instrument comprising:
the electro-optical device as defined in claim 9; and
means that supplies grayscale data to the electro-optical device.

15. An electronic instrument comprising the source driver as defined in claim 5.
